(19) United States
(12) Patent Application Publication
(10) Pub. No.: US 2021/0080039 A1
(43) Pub. Date: Mar. 18, 2021

(54) PUSH-FIT FITTING

(71) Applicant: Accor Technology, Inc., Kirkland, WA (US)

(72) Inventors: Jerry Edward O'Neill, Kirkland, WA (US); Charlie E. Whitney, JR., East Wenatchee, WA (US)

(21) Appl. No.: 16/569,577

(22) Filed: Sep. 12, 2019

(51) Int. Cl. F16L 37/092

(52) U.S. Cl. CPC F16L 37/0925

(57) ABSTRACT

A plumbing fitting couplable with a free-end portion of a pipe. The fitting has a chamber with an opening, and an end bushing with an interior opening sized to receive the pipe free-end portion. An inward seal and gripper ring within the chamber seal with and releasably grip the pipe free-end portion. An anti-intrusion outward seal is positionable within the end bushing interior opening in fluid-tight engagement with an end bushing interior wall portion and the free-end portion of the pipe when positioned within the end bushing interior opening to prevent contaminants reaching an interior portion of the chamber containing the gripper ring and inward seal.

### BACKGROUND OF THE INVENTION

### Field of the Invention

The present invention is directed generally to push-fit type fittings, such as elbows, tees, test caps, couplers, and valves, to permit a push-fit connection of a pipe to a push-fit fitting.

### Description of the Related Art

As is apparent to those of ordinary skill in the art, push-fit fittings typically have an input port with gripper rings to receive a fluid supply pipe or tube to accomplish a push-fit connection to the pipe/tube and an output port which could be a conventional connection or another push-fit connection to which another pipe, tube, hose or other fluid conductor may be connected such that fluid passing through the push-fit fitting is delivered to some desired destination or equipment. A typical use is for conducting water in a plumbing or irrigation system.

When the push-fit fitting is used in a contaminated environment or is in contact with the ground, such as when buried in the ground, contaminants may enter within the housing of the push-fit fitting and reach an internal O-ring and gripper teeth of the push-fit fitting. If such occurs, the contaminants may interfere with proper operation of the push-fit fitting, or damage the push-fit fitting and eventually cause its failure because of the corrosion or dezincification produced by the chemical, mineral and moisture content of the contaminants. As an example, push-fit fittings used in irrigation systems and to connect plumbing from a city water supply to a house plumbing system, may be at least partially, if not entirely, buried in the ground, and even if sitting on the ground, resulting in their exposure to dirt, chemicals in the soil and ground water that may enter the housing and reach the internal O-rings and gripper teeth of the push-fit fitting. In the past in an attempt to avoid such, push-fit fittings required protective bagging.

In view of the above, a need exists for a push-fit fitting that can resist interference with its proper operation and damage when exposed to contaminants.

### BRIEF DESCRIPTION OF THE SEVERAL VIEWS OF THE DRAWING(S)

FIG. 1 is a perspective view of a push-fit fitting of the present invention.

FIG. 2 is a side elevational view of the push-fit fitting of FIG. 1.

FIG. 3 is a cross-section side elevational view of the push-fit fitting of FIG. 1 using two gripper rings and spacer bushings.

FIG. 4 is an enlarged, fragmentary cross-sectional view of the push-fit fitting of FIG. 1.

FIG. 5 is an exploded view of the push-fit fitting of FIG. 1.

FIG. 6 is an enlarged, top perspective view of a gripper ring used with the push-fit fitting of FIG. 1.

FIG. 7 is an enlarged, cross-sectional side elevational view of a spacer bushing and gripper ring assembly used with the push-fit fitting of FIG. 1.

FIG. 8 an enlarged, top perspective view of a spacer bushing used with the push-fit fitting of FIG. 1.

FIG. 9 is a side elevational view of an end bushing and an anti-intrusion O-ring used with the push-fit fitting of FIG. 1.

FIG. 10 is a perspective view of a second embodiment of a push-fit fitting of the present invention in the form of a Tee.

FIG. 11 is a perspective view of a third embodiment of a push-fit fitting of the present invention in the form of a 90-degree elbow.

FIG. 12 is a perspective view of the third embodiment of FIG. 11 with pipe portions illustrated.

Like reference numerals have been used in the figures to identify like components.

### DETAILED DESCRIPTION OF THE INVENTION

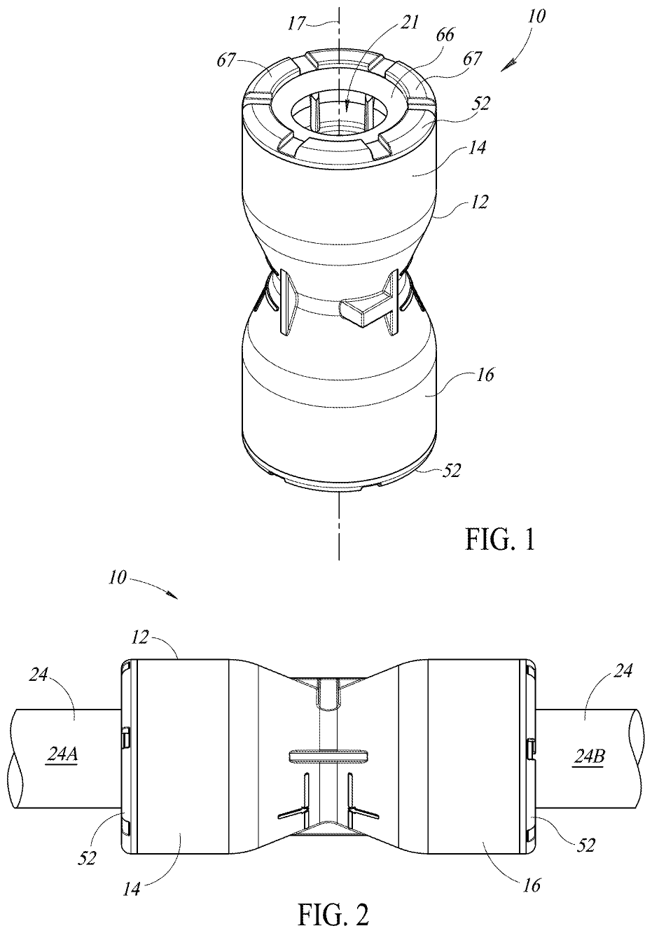

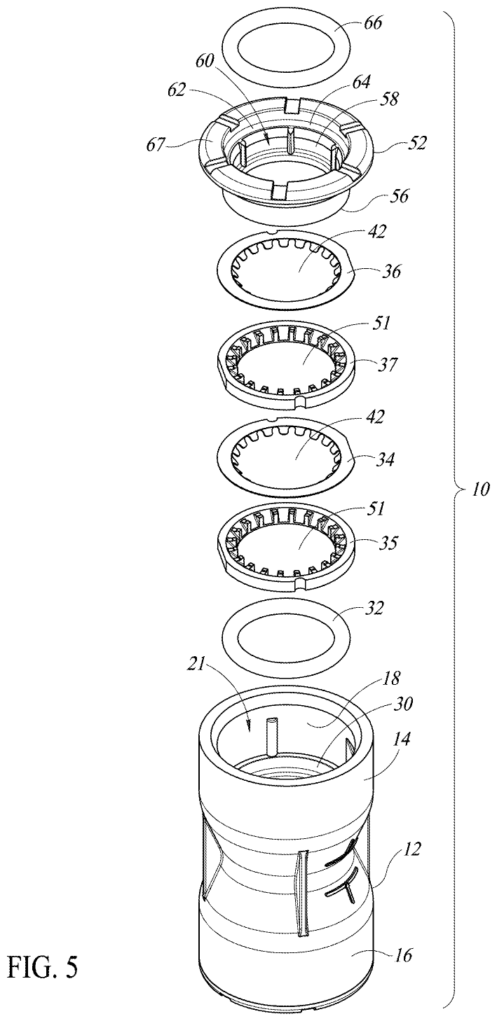

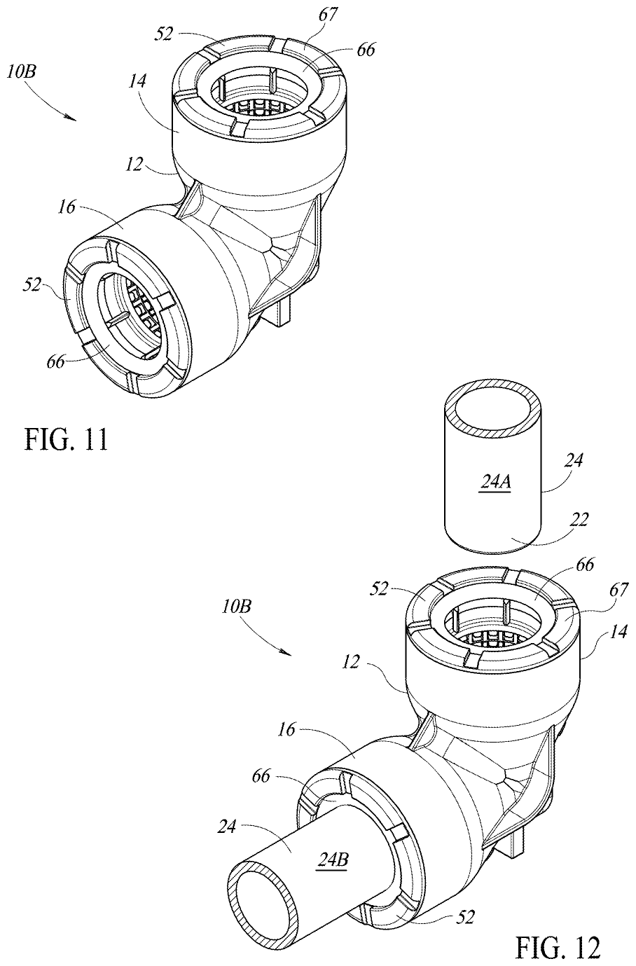

A push-fit plumbing fitting 10 of the present invention suitable for use in a plumbing, irrigation or other system is illustrated as a pipe or tube coupling/coupler in FIGS. 1-9. A second embodiment of the push-fit fitting 10B is illustrated as a Tee in FIG. 10, and a third embodiment of the push-fit fitting 10C is illustrated as a 90-degree elbow in FIGS. 11 and 12. It is to be understood that the present invention may comprise other styles of push-fit fittings, such as test caps, valves and other fittings.

The push-fit fitting 10 of the first embodiment shown in FIGS. 1-9 has the form of a straight coupling/coupler for connecting together two pipes or tubes, and has a housing 12, typically made of plastic or brass. The housing 12 has a first housing portion 14 and a second housing portion 16, in coaxial arrangement along a longitudinal axis 17. The first housing portion 14 has a first axial chamber or bore 18 and the second housing portion 16 has a second axial chamber or bore 20 in coaxial arrangement with the first axial bore. The inward end portion of the first axial bore 18 has an inward fluid port 18A and the inward end portion of the second axial bore 20 has an inward fluid port 20A. The inward fluid ports 18A and 20A are in fluid communication with each other. The outer end portions of the first axial bore 18 and the second axial bore 20 are outwardly open and each has an open outer end 21.

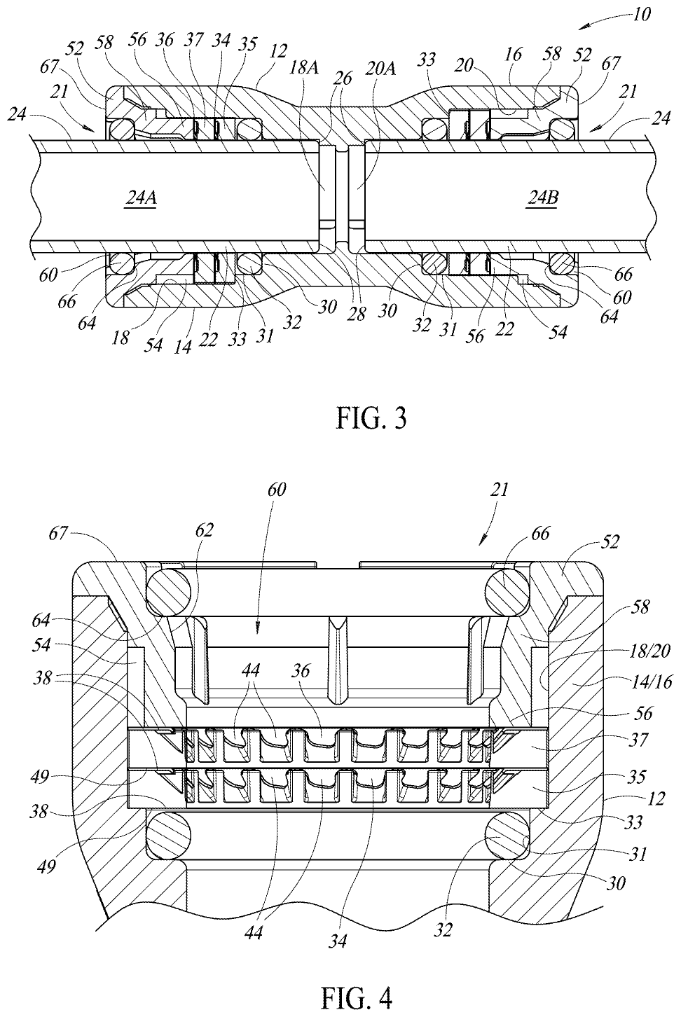

As illustrated in FIGS. 2 and 3, each of the first and second axial bores 18 and 20 is sized to receive therein, through its open outer end 21 of the axial bore, a pipe free-end portion 22 of a smooth outer walled pipe 24 (the pipe shown in the first axial bore 18 is identified by the reference numeral 24A and the pipe shown in the second axial bore 20 is identified by the reference numeral 24B). At the inward end portion of each axial bores 18 and 20 there is an axially outward facing, first shoulder 26 sized to engage an outer end wall 28 of the pipe free-end portion when inserted fully into the axial bore to limit inward movement of the pipe.

Each of the axial bores 18 and 20 further includes an axially outward facing, second shoulder 30 positioned outward of the first shoulder 26 at which an O-ring 32 is positioned. The second shoulder 30 holds the O-ring 32 against inward movement. The O-ring 32 has an interior central opening sized to receive the pipe free-end portion 22 therethrough. The O-ring 32 is sized to provide a fluid-tight seal between the outer wall of the pipe free-end portion 22 and an inner wall portion 31 of the axial bore. In each of the axial bores 18 and 20, a third shoulder 33 is positioned outward of the second shoulder 30 and outward of the O-ring 32.

In each of the axial bores 18 and 20, a first gripper ring 34 and a first spacer bushing 35 are positioned outward of the O-ring 32 with the first spacer bushing against the third shoulder 33 that holds the first spacer bushing against inward movement. A second gripper ring 36 and a second spacer bushing 37 are positioned outward of the first gripper ring 34 and first spacer bushing 35, all being arranged in coaxial alignment.

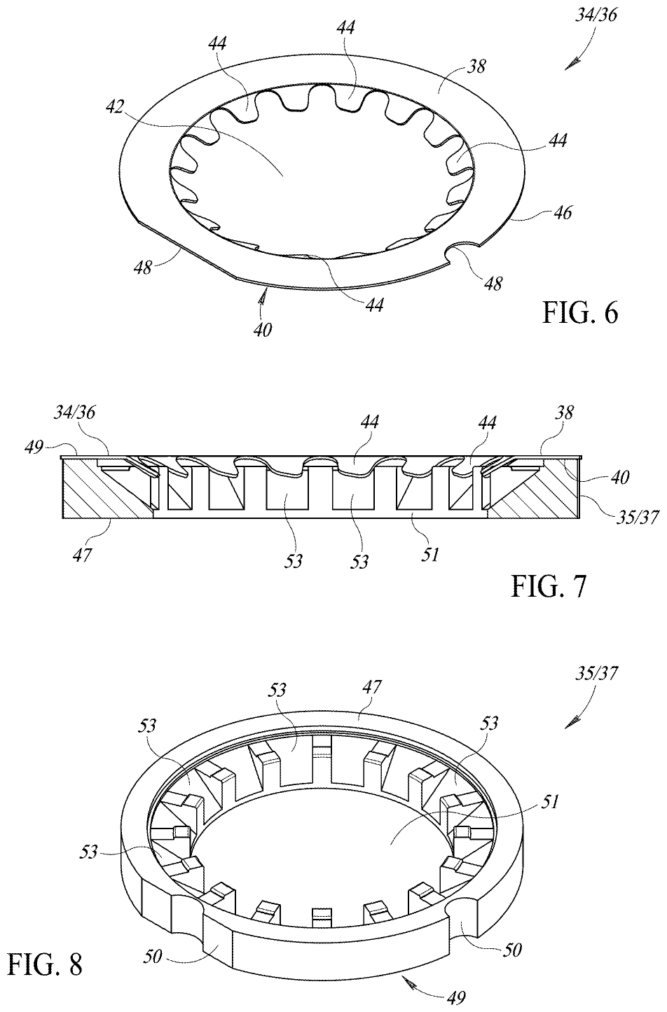

As shown in FIGS. 6 and 7, each of the first and second gripper rings 34 and 36 includes outward and inward facing circumferentially extending smooth perimeter wall portions 38 and 40, respectively, having a central through-hole 42 through which the pipe free-end portion 22 may be inserted and a plurality of circumferentially spaced, axially and radially inwardly protruding teeth 44 that extend into the central through-hole and grip the pipe free-end portion 22 when inserted therein. The teeth 44 grip the pipe free-end portion 22 to prevent its unintentional withdrawal during use.

An outer circumferential edge wall 46 of each of the first and second gripper rings 34 and 36 may include one or more keyways 48 to engage longitudinally extending keys (not shown) on the inner wall portion 31 of the axial bore 18/20 to prevent rotation of the gripper ring within the axial bore. As shown in FIG. 8, each of first and second spacer bushings 35 and 37 may also include one or more keyways 50 to engage the same longitudinally extending keys on the inner wall portion 31 of the axial bore to prevent rotation of the spacer bushings and hence the gripper rings within the axial bore.

The gripper rings 34 and 36 are made of metal and the teeth 44 may each be provided with a twist in a common direction such that the forward most edge of the teeth is bent at an angle to allow the pipe free-end portion 22 of the pipe 24 to be slid past the sharp edges of the ends of the teeth for easy insertion into the axial bore 18/20 past the first and second gripper rings 34 and 36 and the O-ring 32. The teeth 44 will bite into the tubular conduit to prevent its retraction a straight line (i.e., without twisting) and hence securely hold the pipe free-end portion 22 within the axial bore during normal usage of the push-fit fitting 10. However, the bent teeth 44 permit the pipe free-end portion 22 to be easily removed from the axial bore by rotating the pipe free-end portion to effectively unscrew it from the push-fit fitting 10.

As best seen in FIG. 8, each of the first and second spacer bushings 35 and 37 has outward and inward facing circumferentially extending smooth perimeter wall portions 47 and 49, respectively, and a central through-hole 51 through which the pipe free-end portion 22 may be inserted. Each spacer bushing further includes circumferentially spaced axial grooves 53, each with one of the circumferentially spaced teeth 44 of the gripper ring positioned therein when assembled with one of the gripper ring. FIG. 7 shows an assembly of one of the gripper rings 34/36 with one of the spacer bushings 35/37.

The end portion of the first/second housing portions 14/16 of the push-fit fitting 10 is shown enlarged in FIG. 4, with the first gripper ring 34 assembled with the first spacer bushing 35 and the second gripper rings 36 assembled with the second spacer bushing 37. The inward facing perimeter wall portion 49 of the first spacer bushing 35 is in seated engagement with the third shoulder 33 and holds the O-ring 32 in position at the second shoulder 30 against its outward movement, and the inward perimeter wall portion 49 of the second spacer bushing 37 is in seated engagement with the outward facing perimeter wall portion 38 of the first gripper ring 34.

It is to be understood that while the push-fit fitting 10 of the first embodiment is shown using two spacer bushings 35 and 37 and two gripper rings 34 and 36 within each of the first and second axial bores 18 and 20, a single spacer bushing and gripper ring may be used if sufficient to retain the pipe free-end portion 22 within the axial bore when the push-fit fitting is subjected to pressure within the pipes 24. Alternatively, one or both of the first and second axial bores 18 and 20 of the push-fit fitting 10 may use more than a single O-ring 32 and may use more than two gripper rings and spacer bushings to achieve the desired seal with and grip on the pipe free-end portion 22. Further, the O-rings, gripper rings and spacer bushings may be in different sequential positions within the axial bores. Still further, while the push-fit fitting 10 is illustrated as being used with pipes 24, the pipes may have a hard sidewall or have a soft sidewall such as does PEX and PE-RT tubing and tubing made of other materials.

An annular end bushing 52 is positioned in an open-end portion 54 of each of the axial bores 18 and 20, and secured to the first and second housing portions 14 and 16, respectively, in fluid-tight engagement therewith. The end bushing 52 of each of the first and second housing portions 14 and 16 retains the O-ring 32, the gripper rings 34 and 36, and the spacer bushings 35 and 37 within the axial bores 18 and 20, respectively, against axially outward movement. The end bushing 52 may be secured in fluid-tight engagement with the housing portions using an adhesive, welding or by any other satisfactory means. The end bushing 52 extends inward into the axial bore 18/20 sufficiently that an inward circumferentially extending end portion 56 of the end bushing engages the outer perimeter wall portion 38 of the second gripper ring 36, to hold the gripper rings and the spacer bushings tightly sandwiched together between the third shoulder 33 and the inward end portion 56 of the end bushing 52. It also limits axial movement of the O-ring 32 that is positioned between the second shoulder 30 and the inward perimeter wall portions 47 of the first spacer bushing 35.

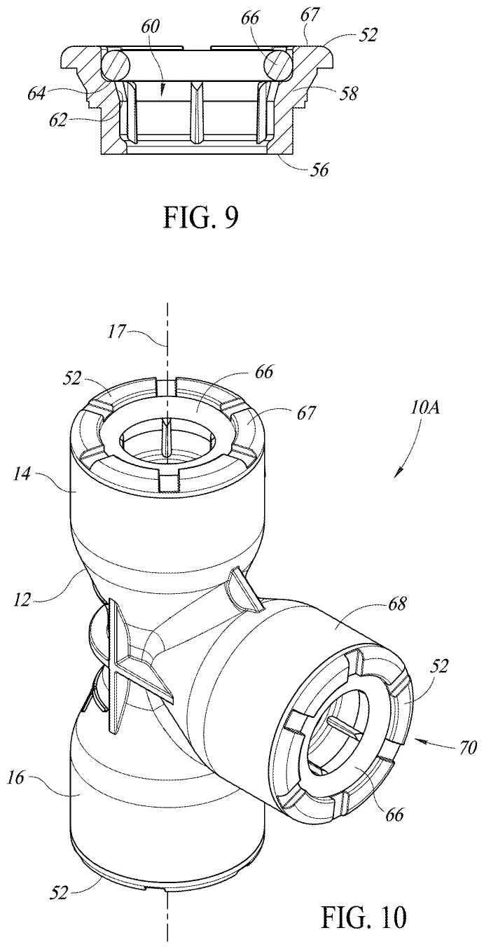

The end bushing 52 has a perimeter sidewall 58 defining an interior axially extending passageway 60. An inner wall portion 62 of the perimeter sidewall 58 has an axially outward facing, circumferentially extending shoulder 64 that supports an O-ring 66 against inward movement. The end bushing 52 has an outward wall 67, and the O-ring 66 when positioned against the shoulder 64 is positioned inward of the outward wall 67 of the end bushing. The O-ring 66 has an interior central opening sized to receive the pipe free-end portion 22 therethrough. The O-ring 66 is sized to provide a fluid-tight seal between the outer wall of the pipe free-end portion 22 and the inner wall portion 62 of the end bushing perimeter sidewall 58. The O-ring 66 prevents the intrusion of contaminants, such as dirt, chemicals in the soil and ground water when the push-fit fitting 10 is used in an irrigation system or water supply system where the push-fit fitting is buried in the ground or otherwise exposed to such elements, into the interior portions of the first and second housing portions 14 and 16 containing the first and second gripper rings 34 and 36, the first and second spacer bushings 35 and 37, and the O-ring 32. It is noted that without the presence of the O-ring 66, contaminants are free to pass between the outer wall of the pipe free-end portion 22 and the perimeter sidewall 58 of the end bushing, when the pipe free-end portion is inserted through the interior axially extending passageway 60 of the end bushing 52. This results in the contaminants reaching the interior portion of the first/second housing portions 14/16 of the push-fit fitting 10 located outward of the O-ring 32, and coming into contact with the metal gripper rings 34/36 and the spacer bushings 35/37, as well as the O-ring 32. The O-ring 66, by preventing this intrusion, avoids the contaminants interfering with the proper operation of the push-fit fitting 10, or damaging the push-fit fitting and eventually cause its failure as a result of the corrosion or dezincification produced by the chemical, mineral and moisture content of the contaminants. It also avoids the need to place the push-fit fitting into a bag to protect it, a technique which is not always effective. The end bushing 52 is shown in FIG. 9 removed from the housing 12 with the O-ring 32 in position thereon.

The O-ring 66 may be inserted into the interior axially extending passageway 60 of the end bushing 52 into position on the axially outward facing, circumferentially extending shoulder 64, and then the pipe free-end portion 22 may be inserted into the interior axially extending passageway 60 and through the interior central opening of the O-ring 66. The pipe may then be passed fully through the O-ring 66 and through the central through-hole 42 of the gripper rings 34/36 and the central through-hole 51 of the spacer bushings 35/37, and finally through the interior central opening of the O-ring 32. Alternatively, the O-ring 66 may be positioned on the pipe free-end portion 22, and then the pipe free-end portion may be inserted into the interior axially extending passageway 60 of the end bushing 52 and passed through the central through-hole 42 of the gripper rings 34/36 and the central through-hole 51 of the spacer bushings 35/37, and finally through the interior central opening of the O-ring 32. Then, the O-ring 66 may be slid along the pipe free-end portion 22 toward the end bushing 52 until in position on the axially outward facing, circumferentially extending shoulder 64 of the end bushing 52. In either case, should it be necessary to remove the pipe free-end portion 22 from the push-fit fitting 10, the axially outward facing, circumferentially extending shoulder 64 permits the O-ring 66 to be easily removed and replaced with a new O-ring before the pipe free-end portion 22 (or a replacement pipe free-end portion) is reinserted into the push-fit fitting.

A second embodiment of the push-fit fitting 10A is illustrated as a Tee in FIG. 10. The housing 12, in addition to the first and second housing portions 14 and 16 described above, has a third housing portion 68 positioned between the first and second housing portions, and having a third axial bore 70 oriented transverse to the longitudinal axis 17. The inward end portion of the third axial bore 70 is in fluid communication with the inward end portions of the first and second axial bores 18 and 20. The outer end portion of the third axial bore 70 is open and the third housing portion 68 includes the first and second gripper rings 34 and 36, the first and second spacer bushings 35 and 37, the O-ring 32, the end bushing 52, and the O-ring 66, described above.

A third embodiment of the push-fit fitting 10B is illustrated as a 90-degree elbow in FIGS. 11 and 12. The housing 12 includes the same first and second housing portions 14 and 16 described above, except that the second housing portion has a longitudinal axis oriented at 90 degrees to the longitudinal axis of the first housing portion 14. As with the embodiment of FIG. 1, each of the first and second housing portions 14 and 16 include the first and second gripper rings 34 and 36, the first and second spacer bushings 35 and 37, the O-ring 32, the end bushing 52, and the O-ring 66, described above.

It is to be understood that while all of the embodiments described herein use the first and second gripper rings 34 and 36, the first and second spacer bushings 35 and 37, the O-ring 32, the end bushing 52, and the O-ring 66 described above in each housing portion, the invention is intended to include fittings wherein only one housing portion uses these components. This would include a test cap that typically includes only a single housing portion, and alternative fittings that have more than one housing portion but use these components in only one of those housing portions. As noted above, the invention is intended to also cover push-fit fitting which using any number of gripper rings within a housing portion without any number of spacer bushings or even without any spacer bushings.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A plumbing fitting couplable with a free-end portion of a pipe, comprising:
a housing having a chamber with a chamber opening;
an end bushing having an end bushing interior wall portion with an end bushing interior opening sized for positioning of the free-end portion of the pipe therein and an end bushing exterior wall portion located within the chamber opening;
an inward seal having an inward seal interior opening, the inward seal being located within the chamber in fluid-tight engagement with the housing and positioned for fluid-tight engagement with the free-end portion of the pipe when positioned within the inward seal interior opening;
a gripper ring having a gripper ring interior opening, the gripper ring being located within the chamber, the gripper ring including gripper teeth extending inwardly into the gripper ring interior opening in position for gripping engagement with the free-end portion of the pipe when positioned within the gripper ring interior opening to resist non-rotational movement of the pipe out of the chamber opening; and
an anti-intrusion outward seal having an outward seal interior opening, the outward seal being positionable within the end bushing interior opening in fluid-tight engagement with the end bushing interior wall portion, at position outward of the gripper ring, and positioned for fluid-tight engagement with the free-end portion of the pipe when positioned within the end bushing interior opening and extending through the outward seal interior opening.

2. The plumbing fitting of claim 1, wherein the end bushing has an axially outward facing, circumferentially extending shoulder that supports the outward seal against inward movement.

3. The plumbing fitting of claim 1, wherein the end bushing is secured to the housing in fluid-tight engagement therewith.

4. The plumbing fitting of claim 1, wherein the outward seal is an O-ring.

5. The plumbing fitting of claim 1, further including a spacer bushing having a spacer bushing opening, the spacer bushing being located within the chamber adjacent to the gripper ring.

6. The plumbing fitting of claim 1, wherein the inward seal is located within the chamber inward of the gripper ring.

7. The plumbing fitting of claim 1, wherein the chamber has a longitudinal axis, and the end bushing holds the gripper ring and the inward seal against axial outward movement within the chamber.

8. The plumbing fitting of claim 1, wherein the gripper ring is retained against rotation within the chamber.

9. The plumbing fitting of claim 1, further including:
a second gripper ring having a second gripper ring interior opening, the second gripper ring being located within the chamber, the second gripper ring including gripper teeth extending inwardly into the second gripper ring interior opening in position for gripping engagement with the free-end portion of the pipe when positioned within the second gripper ring interior opening to resist non-rotational movement of the pipe out of the chamber opening.

10. The plumbing fitting of claim 1, wherein the end bushing has an outward wall, and the outward seal is positioned within the end bushing inward of the outward wall of the end bushing.

11. The plumbing fitting of claim 1, wherein an outward end portion of the end bushing has a circumferentially extending recess extending about the end bushing interior opening, and the outward seal is removably positioned in the recess.

12. A plumbing fitting couplable with a free-end portion of a first pipe and a second pipe, comprising:
a housing having a first housing portion with a first chamber having a first chamber opening and a first chamber inward fluid port, and a second housing portion with a second chamber having a second chamber opening and a second chamber inward fluid port, the first and second chamber inward fluid ports being in fluid communication;
a first end bushing having a first end bushing interior wall portion with a first end bushing interior opening sized for positioning of the free-end portion of the first pipe therein and a first end bushing exterior wall portion located within the first chamber opening;
a first inward seal having a first inward seal interior opening, the first inward seal being located within the first chamber in fluid-tight engagement with the first housing portion and positioned for fluid-tight engagement with the free-end portion of the first pipe when positioned within the first inward seal interior opening;
a first gripper ring having a first gripper ring interior opening, the first gripper ring being located within the first chamber portion, the first gripper ring including first gripper teeth extending inwardly into the first gripper ring interior opening in position for gripping engagement with the free-end portion of the first pipe when positioned within the first gripper ring interior opening to resist non-rotational movement of the first pipe out of the first chamber opening;
a first outward seal having a first outward seal interior opening, the first outward seal being positionable within the first end bushing interior opening in fluid-tight engagement with the first end bushing interior wall portion, at position outward of the first gripper ring, and positioned for fluid-tight engagement with the free-end portion of the first pipe when positioned within the first end bushing interior opening and extending through the first outward seal interior opening;
a second end bushing having a second end bushing interior wall portion with a second end bushing interior opening sized for positioning of the free-end portion of the second pipe therein and a second end bushing exterior wall portion located within the second chamber opening;
a second inward seal having a second inward seal interior opening, the second inward seal being located within the second chamber in fluid-tight engagement with the second housing portion and positioned for fluid-tight engagement with the free-end portion of the second pipe when positioned within the second inward seal interior opening;
a second gripper ring having a second gripper ring interior opening, the second gripper ring being located within the second chamber portion, the second gripper ring including second gripper teeth extending inwardly into the second gripper ring interior opening in position for gripping engagement with the free-end portion of the second pipe when positioned within the second gripper ring interior opening to resist non-rotational movement of the second pipe out of the second chamber opening; and
a second outward seal having a second outward seal interior opening, the second outward seal being positionable within the second end bushing interior opening in fluid-tight engagement with the second end bushing interior wall portion, at position outward of the second gripper ring, and positioned for fluid-tight engagement with the free-end portion of the second pipe when positioned within the second end bushing interior opening and extending through the second outward seal interior opening.

13. The plumbing fitting of claim 12, wherein the first chamber has a first longitudinal axis and the second chamber has a longitudinal axis, the first and second longitudinal axes being coaxially arranged.

14. The plumbing fitting of claim 12, wherein the first chamber has a first longitudinal axis and the second chamber has a longitudinal axis, the first longitudinal axis being transverse to the second longitudinal axis.

15. The plumbing fitting of claim 12, wherein the first end bushing has a first axially outward facing, circumferentially extending shoulder that supports the first outward seal against inward movement, and the second end bushing has a second axially outward facing, circumferentially extending shoulder that supports the second outward seal against inward movement.

16. The plumbing fitting of claim 12, wherein the first end bushing is secured to the first housing portion in fluid-tight engagement therewith, and the second end bushing is secured to the second housing portion in fluid-tight engagement therewith.

17. The plumbing fitting of claim 12, wherein the first outward seal is an O-ring, and the second outward seal is an O-ring.

18. The plumbing fitting of claim 12, further including a first spacer bushing having a first spacer bushing opening, the first spacer bushing being located within the first chamber adjacent to the first gripper ring, and a second spacer bushing having a second spacer bushing opening, the second spacer bushing being located within the second chamber adjacent to the second gripper ring.

19. The plumbing fitting of claim 12, wherein the first inward seal is located within the first chamber inward of the first gripper ring, and the second inward seal is located within the second chamber inward of the second gripper ring.

20. The plumbing fitting of claim 12, wherein the first chamber has a first longitudinal axis, and the first end bushing holds the first gripper ring and the first inward seal against axial outward movement within the first chamber, and the second chamber has a second longitudinal axis, and the second end bushing holds the second gripper ring and the second inward seal against axial outward movement within the second chamber.

21. The plumbing fitting of claim 12, wherein the first gripper ring is retained against rotation within the first chamber, and the second gripper ring is retained against rotation within the second chamber.

22. The plumbing fitting of claim 12, wherein the first end bushing has a first outward wall, and the first outward seal is positioned within the first end bushing inward of the first outward wall of the first end bushing, and the second end bushing has a second outward wall, and the second outward seal is positioned within the second end bushing inward of the second outward wall of the second end bushing.

23. The plumbing fitting of claim 12, wherein a first outward end portion of the first end bushing has a first circumferentially extending recess extending about the first end bushing interior opening, and the first outward seal is removably positioned in the first recess, and a second outward end portion of the second end busing has a second circumferentially extending recess extending about the second end bushing interior opening, and the second outward seal is removably positioned in the second recess.
